(19) United States
(12) Patent Application Publication
(10) Pub. No.: US 2025/0134302 A1
(43) Pub. Date: May 1, 2025

(54) TABLETOP GRILL AND FILTER APPLIANCE

(71) Applicant: DOMO VISION AG, Oftringen (CH)

(72) Inventor: Georg Feierabend, Aarburg (CH)

(21) Appl. No.: 18/837,271

(22) PCT Filed: Feb. 10, 2023
(86) PCT No.: PCT/EP2023/053364

§ 371 Date: Aug. 9, 2024

(30) Foreign Application Priority Data
Feb. 15, 2022 (CH) CH000143/2022

(51) Int. Cl. A47J 37/06; A47J 27/00; A47J 36/38; F24C 15/20; H05B 3/68

(52) U.S. Cl. CPC A47J 37/0605; A47J 27/004; A47J 36/38; F24C 15/2035; F24C 15/2042; H05B 3/68

(57) ABSTRACT

An electric tabletop grill has support elements, such as feet, for placement on a table surface, as well as an electric heater for heating food on the dining table. The tabletop grill also has a fan, a filter, and suction openings provided in the appliance. The fan is arranged such that, in operation, the fan draws air through the suction openings into a filter chamber and causes the air to flow through the filter and then out of the filter chamber through at least one blow-out opening.

### BACKGROUND OF THE INVENTION

### Field of the Invention

The invention relates to an electric tabletop grill and a filter appliance.

### Description of Related Art

Tabletop grill appliances are intended to be placed on the dining table during a meal so that those present can prepare their own food. For this purpose, the appliances have corresponding feet that allow them to be placed on the table board without damaging it, e.g. by excessive heat input.

Tabletop grill appliances include both, appliances with a heated grill plate on which the food to be prepared is placed, and appliances of the “raclette stove” type in which the food is placed on pans under an electric heater and heated from above. Of particular interest are raclette stoves with a grill plate, which combine the two functions by providing a slot underneath the grill plate, and the electric heater below it for the pans to prepare raclette.

A well-known problem in the preparation of food is the development of odours. In the kitchen area, this problem is addressed by steam extraction devices. Completely or partially closed stoves with a grill function and with an extraction device, for example with a filter, are also known, for example from EP 2 767 764. However, such extraction devices are not in use for tabletop appliances, since extractor hoods, closed housings or cover plates, under which the vapours produced can be extracted, do not represent an option compatible with the function of the appliances.

### SUMMARY OF THE INVENTION

It is an object of the present invention to provide a solution which overcomes disadvantages of the prior art and which solves the problem of odour development without impairing functionality.

According to a first aspect of the invention, an electric tabletop grill is provided. In a manner known per se, the tabletop grill has support elements, in particular feet, for placing it on a table surface and an electric heater for heating food on the dining table. It is also characterised by a fan, a filter and suction openings in the appliance. The fan is arranged so that, in operation, it draws air through the suction openings into a filter chamber and causes the air to flow through the filter and then out of the filter chamber through at least one exhaust opening.

The fan can, referring to a direction of flow, be arranged upstream or downstream of the filter. An arrangement downstream of the filter has the advantage that the fan is exposed to less contamination.

The support elements are generally designed in such a way that they do not heat up significantly when the electric heater is operated.

It is a finding of the invention that a system with suction openings, filter and fan is also useful for table-top grills, although these are neither designed as a closed stove nor do they have an extractor hood or similar. Experiments with visible smoke, for example, show that the air flow generated by a fan away from the food to be grilled or the cheese to be melted through a filter is sufficient to eliminate at least a significant proportion of the odour development. This also applies if the air flow neither leads upwards (as in the case of an extractor hood) nor can be led along a ceiling in a completely or partially closed volume. The air flow that can be generated by a fan sufficiently counteracts the tendency for odour-contaminated gas mixtures and oil droplets to rise upwards due to heating.

The at least one filter may in particular be an activated carbon filter.

It is particularly advantageous if the filter chamber with the fan is arranged centrally inside the tabletop grill, so that grilling surfaces and/or receiving seats for pans are provided on both sides of the filter chamber. The tabletop grill is thus divided by the filter chamber into two sections (e.g. halves), each of which has support places for pans and/or a section of a grill plate. The two sections of the tabletop grill appear to the user as a front or rear section, but this does not exclude that, as is known per se, there are also support places to be operated from the sides. Overall, the tabletop grill may have an approximately rectangular or elliptical layout, with the filter chamber extending approximately centrally along the longer axis. However, square or substantially circular layouts are not excluded.

Thus, the tabletop grill may in particular be designed in such a way that, when placed on a table, it is accessible from at least two opposite sides and may be operated from both sides, for example by placing food to be grilled and/or by inserting pans, the filter chamber being located between the two sides, for example centrally.

As an alternative to an arrangement of the filter chamber in the centre, a design in which the filter chamber is arranged laterally is also possible. Such a lateral arrangement can be a good alternative especially—but not only—for smaller table-top grills with only 6 or only 4 or less places.

An arrangement in which the fan is a radial fan is particularly favourable. According to the terminology used here, so-called tangential fans or cross-flow fans are considered radial fans. Tangential fans draw in the air tangentially and discharge it again tangentially and are often characterised by a particularly long fan axis in relation to the circumference, whereby the air is drawn in and blown out over essentially the entire length of the axis. Tangential fans are a particularly favourable design of radial fan for all aspects of the invention.

In particular, the axis of rotation of the radial fan (e.g., tangential fan) may be horizontal. The tabletop grill defines by its design a vertical and a horizontal, and it can further be designed—in particular by a substantially rectangular or elliptical layout as mentioned above—in such a way that in the horizontal plane also a longitudinal axis (connection between users sitting opposite each other) and a transversal axis (perpendicular to the longitudinal axis) are defined, whereby the transversal extension (width) of the tabletop grill is larger than the longitudinal extension (depth). In such a case, it can be particularly favourable if the axis of rotation of the radial fan is transversal, i.e. parallel to the axis of the greater extension in the horizontal. However, especially in the case of a lateral arrangement of the filter chamber, a longitudinal arrangement of the axis of rotation of the radial fan can also be a good option.

The use of a radial fan, especially a tangential fan, has the advantage that the air is transported over a comparatively large width—corresponding to the axial expansion of the radial fan—and therefore a largely parallel flow guidance through the filter(s) is possible. This geometry helps to reduce the flow resistance and, accordingly, the possible noise pollution—in addition to the generally lower noise development of radial fans compared to axial fans anyway.

The filter chamber (and, if applicable, the radial fan) can extend over a large part of the transverse width of the tabletop grill, so that the suction opening or suction openings also extend(s) to the outer support places and/or also to the peripheral area of the grill plate. Thus, no essential transport of the air in transverse directions is necessary. “Over a large part of the width” can mean, for example in a design with support places for pans, that the filter chamber extends so far that it extends to a position that is distanced from the outer edges of the support (which is formed by the support places) by at most half a width of a support place.

Often a tabletop grill is designed to provide space for simultaneous operation by a plurality of persons; in particular, in a substantially rectangular or elliptical layout, support spaces may be provided in two opposing rows of pans, as appropriate. The suction openings are then arranged between the rows, for example. In particular, at least one suction opening or a row of several suction openings may be present on both sides, i.e. towards both rows.

The suction opening(s) or at least some of the suction openings may be formed in a vertical wall of the housing which runs between the rows of support places or between the sections of the grill plate. Instead of forming a row of suction openings, there may also be an elongated suction opening, e.g. one such suction opening on each side.

The tabletop grill can in particular be a combination appliance, as known per se, in that both, a grill plate and a receiving space for pans are present, whereby generally only a single electric heater is required, which is arranged directly below the grill plate and above a receiving space with the support places for the pans.

In such a configuration, the tabletop grill may have at least one upper suction opening and at least one lower suction opening, the upper suction opening being open to the space above the grill plate and the—generally multiple—lower suction openings being open to the receiving space.

In particular, the tabletop grill may have a transverse ledge which extends between the portions of the grill plate and in which the upper suction opening(s) is/are provided. Such a ledge prevents food from being accidentally placed on the suction openings. The upper suction openings can be provided on both sides of a vertical wall formed by the ledge.

Lower suction openings can be formed on a vertical wall. They can be present, for example, on the upper side of the receiving space, below the electric heater.

The suction opening(s) can be closable and/or adjustable. If upper and lower suction openings are present, they can be closable or adjustable independently of each other. In one example, the tabletop grill has one or more sliders that can be moved to open or close the suction openings. Such a slider may, for example, be provided in a simple manner with holes whose size corresponds at least to the size of the suction openings and which, by moving the slider, are brought from a position in which they are aligned with the suction openings to a position in which this is not the case and the slider closes the suction openings.

According to a second aspect, the invention relates to a filter appliance which is independent of the tabletop grill and can be placed, for example, next to a conventional tabletop grill that does not have a fan. Like the tabletop grill, it is intended to be placed on a table surface of a laid table. It has a housing with suction openings and at least one exit opening. The appliance has an overall elongated rectangular cuboid shape, the length being significantly greater (e.g., by at least a factor of 1.8, in particular at least a factor of 2, e.g., a factor of 2.5 or more) than the width and the height. A tangential fan is arranged inside the housing. The axis of rotation of the tangential fan is parallel to the longitudinal axis of the filter unit. Along the tangential fan extends a filter chamber with at least one activated carbon filter, which also extends in the longitudinal direction. The tangential fan causes air to be sucked in through the suction openings, to then flow through the filter or filters and to be blown out through the exit opening(s).

The overall elongated shape is particularly advantageous in connection with the use of the radial fan, as it enables it to be placed on the table as required, whereby a vertical arrangement (longitudinal extension and fan axis are vertical) is particularly space-saving. Even if the required power of the fan is somewhat greater than in the approach according to the first aspect, since the suction openings cannot be so close to the grilled or cooked food, the elongated design with radial fan nevertheless ensures that air can be drawn in and cleaned relatively efficiently over a wide area.

### BRIEF DESCRIPTION OF THE DRAWINGS

In the following, the subject of the invention will be explained in more detail with reference to examples of embodiments and the accompanying drawings. In the drawings, identical reference signs denote identical or analogous elements. They show:

FIG. 1 a view of a tabletop grill;

FIGS. 2 and 3 a view of the tabletop grill of FIG. 2 from the operating side and from above, respectively;

FIG. 4 a sectional view of the tabletop grill (section along plane IV-IV in FIG. 3);

FIG. 5 a view of a filter unit according to the second aspect; and

FIG. 6 a sectional view of the filter unit of FIG. 5.

### DETAILED DESCRIPTION OF THE INVENTION

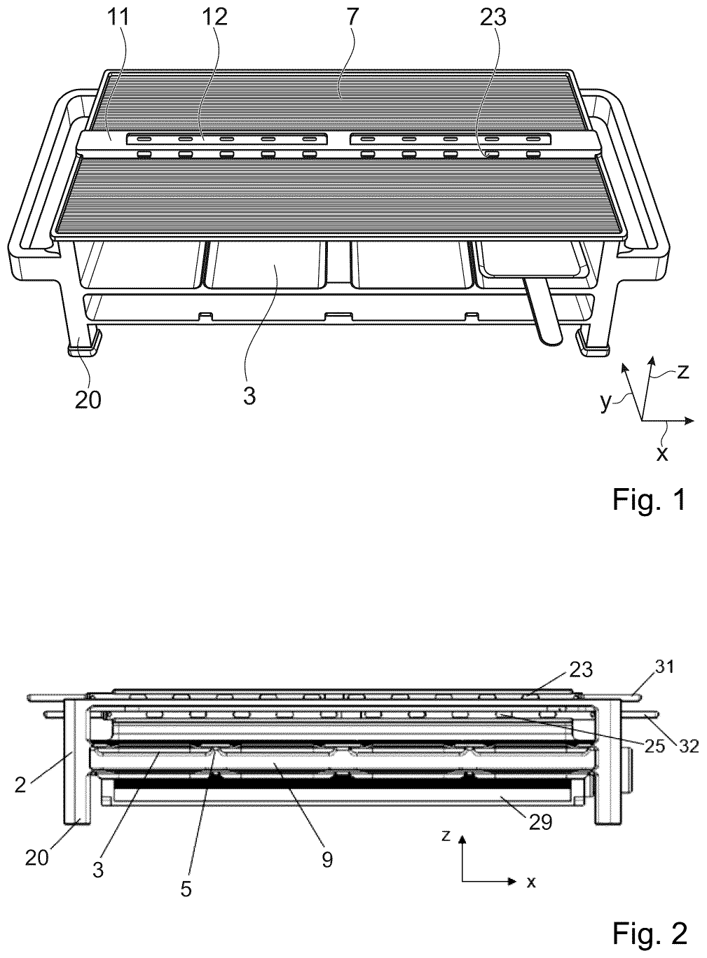

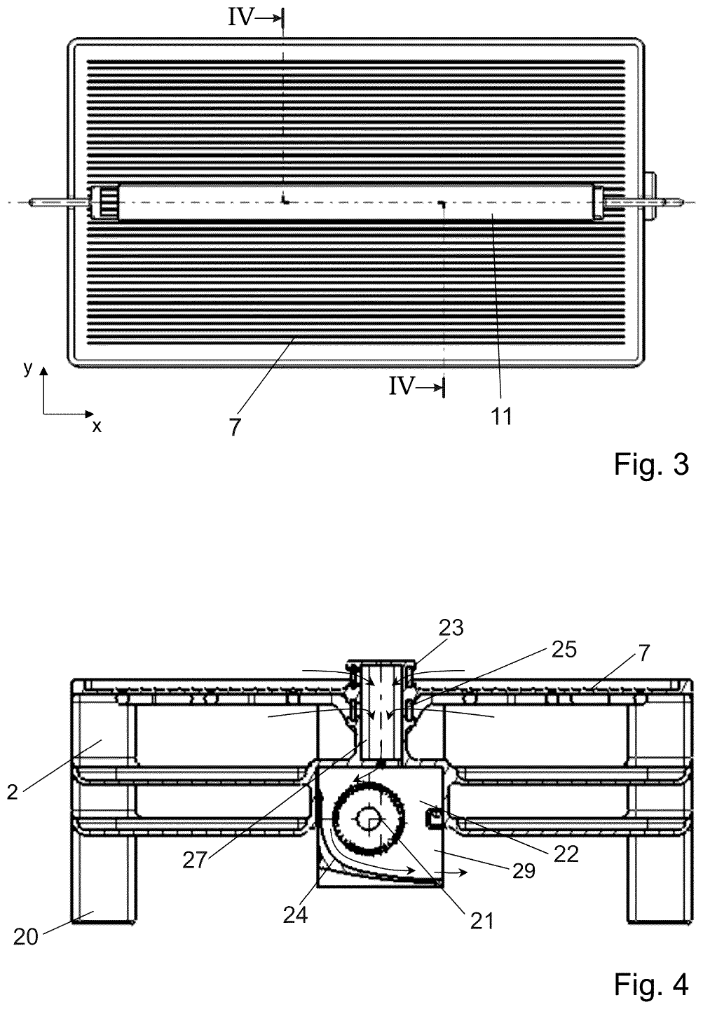

FIGS. 1 to 3 show a tabletop grill 1 of the “raclette stove with grill plate” type.

The tabletop grill 1 has a frame with four columns 2, each of which forms a foot 20 on the underside. It has an electric heater in the form of a heating rod or heating coil or the like. Below the electric heater there are support places 3 for pans. Positioning aids 5 are arranged between the support places 3, the distance and course of which are adapted to the dimensions of the pans. The grill plate 7 can be ribbed in a manner known per se or have another surface shape optimised for the grilling function. Below the support places 3 for the pans, an optional non-heated storage surface 9 is formed, on which pans that are not in use can be placed without heating up.

The tabletop grill has an overall approximately rectangular layout, so that there are two rows of support places 3 opposite each other, in the drawn embodiment example four support places each. The grill plate is also divided into two halves, separated by a ledge 11. One of the halves is the front half and the other one is the rear half from the user's point of view.

FIGS. 1-3 also show a Cartesian coordinate system, where the z-axis corresponds to the vertical and the x-axis to the transverse, i.e. the support places 3 for the pans are lined up next to each other in the x-direction. The pans are pushed in and pulled out in the y-direction or −y-direction, which is why y- or minus-y-directions are also called “longitudinal directions” in this text.

As can be seen in particular in FIG. 4, the tabletop grill has an air extraction system. This is arranged inside the tabletop grill, between the opposing rows of support places 3. The air extraction system includes a fan 21, namely a radial fan of the “tangential fan” type, the axis of rotation of which is arranged parallel to the transverse direction (x-direction) and which extends over a large part of the width (transverse extension) of the tabletop grill. The fan sucks in air tangentially through upper suction openings 23, which are provided on both sides of the bar and/or through lower suction openings 25, which are arranged below the grill plate, guides it through a filter chamber 27 with at least one activated charcoal filter and blows it out filtered through a blow-out opening 29. The direction of air flow is illustrated with arrows in FIG. 4. Inside a fan chamber 22 containing the fan 21 and, if necessary, also elsewhere in the area of the air flow to be generated, e.g. in the filter chamber, a flow directing element 24 or several flow directing elements can support the action of the fan 21.

The fan is electrically driven and includes an electric motor for this purpose. The tabletop grill may be configured so that the fan is constantly in operation when the tabletop grill is connected to the mains or when a main switch is turned on. However, it can optionally be switched on and off by a user; different fan speeds are also possible; possibly such can also be dependent on the state of the sliding elements or similar (described below) which open or close the suction openings. For this purpose, the state of the sliders (or other elements with which the suction openings can be opened or closed) can be sensed by a switch or sensor.

In FIG. 1, two top maintenance slots 12 are visible on the ledge 11, which slots 12 can be closed and are closed in use.

The upper suction openings 23 and the lower suction openings 25 can be closed independently of each other (i.e. the upper suction openings 23 can be opened or closed independently of whether the lower suction openings 25 are open or closed, and vice versa). In the embodiment example shown, this is realised by a sliding element 31 on the upper side for the upper suction openings 23 and a sliding element 32 on the lower side for the lower suction openings.

The size of the tabletop grill 1 is designed for the indoor table top grill 1 to be placed on a set table to accompany a meal. The width (transversal extension) is typically between 40 cm and 70 cm, the depth (longitudinal extension), generally between 20 cm and 40 cm, the height between 8 cm and 25 cm.

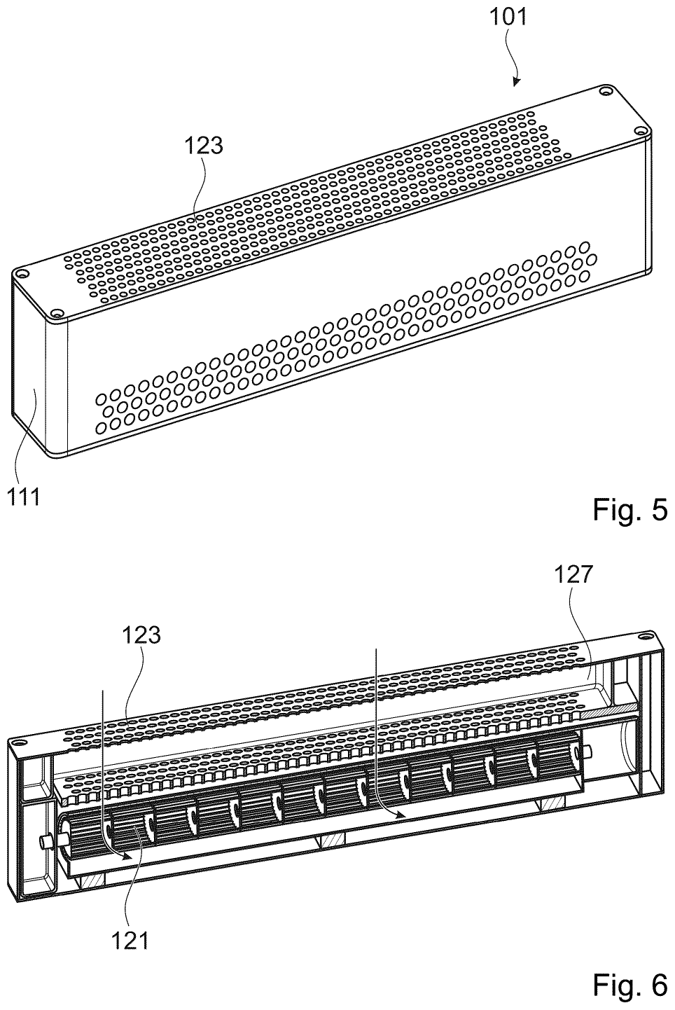

A filter appliance 101 according to the second aspect of the invention is seen in FIGS. 5 and 6. The appliance has a housing 111 with suction openings 123 and exit openings (not visible in FIGS. 5 and 6). The appliance has an overall elongate cuboid shape, with the length being significantly greater than the width and height. A fan, namely a radial fan of the “tangential fan” type 121, is arranged inside the housing 111. The tangential fan is aligned along the longitudinal extension of the housing 111, i.e. the axis of rotation of the tangential fan is parallel to the longitudinal axis of the filter unit. Along the tangential fan, a filter chamber 127 with at least one activated carbon filter also extends in the longitudinal direction. The tangential fan causes air to be drawn in through the suction openings 123, to then flow through the filter(s) and to be blown out through the exit openings.

1. An electric tabletop grill comprising a housing with support elements for supporting the tabletop grill on a table surface, and an electric heater, said electric tabletop grill further comprising an electrically drivable fan and at least one filter, and wherein the housing forms a filter chamber and at least one suction opening, the at least one filter being arranged in the filter chamber, and the fan being arranged such that in one operating state air is sucked in through the at least one suction opening and is conveyed therefrom into the filter chamber and out of the filter chamber through the at least one filter.

2. The tabletop grill according to claim 1, wherein the filter chamber is centrally arranged in the tabletop grill, so that on both sides of the suction opening or suction openings there are support places for pans and/or portions of a grill plate.

3. The tabletop grill according to claim 2, wherein at least one suction opening is present on each side.

4. The tabletop grill according to claim 2, comprising a transverse ledge on the upper side, on each side of which a portion of a grill plate extends, wherein the suction opening or at least one of the suction openings is present on the transverse ledge.

5. The tabletop grill according to claim 1, having a rectangular or elliptical layout, wherein the filter chamber in the tabletop grill extends transversely along a main axis.

6. The tabletop grill according to claim 1, wherein the fan is a tangential fan.

7. The tabletop grill according to claim 6, comprising a rectangular or elliptical layout, wherein an axis of rotation of the tangential fan is horizontal and parallel to the dimension of greatest horizontal extension.

8. The tabletop grill according to claim 1, comprising a grill plate above the electric heater and a receiving space for pans below the grill plate.

9. The tabletop grill according to claim 8, comprising at least one upper suction opening and one lower suction opening, wherein the upper suction opening is open towards a space above the grill plate and the lower suction opening is open towards the receiving space.

10. The tabletop grill according to claim 1, wherein the at least one suction opening is closable and/or has an adjustable cross-section.

11. A filter appliance, for being placed on a dining table in the vicinity of a tabletop grill, comprising a housing with suction openings and at least one exit opening, wherein the filter appliance has a cuboid shape, wherein an extension along a longitudinal axis is greater than a width and a height by at least a factor of 1.8, the filter appliance further comprising a tangential fan arranged inside the housing, the axis of rotation of which is parallel to the longitudinal axis, a filter chamber extending parallel to the longitudinal axis and comprising at least one activated carbon filter extending along the tangential fan, and the tangential fan being arranged to cause air to be sucked in through the suction openings, to subsequently flow through the at least one filter and to be blown out through the at least one exit opening.
